(19) United States
(12) Patent Application Publication
(10) Pub. No.: US 2023/0316902 A1
(43) Pub. Date: Oct. 5, 2023

(54) TRAFFIC FLOW MIGRATION SITUATION DISPLAY METHOD AND APPARATUS, DEVICE, MEDIUM AND PRODUCT

(71) Applicant: Tencent Technology (Shenzhen) Company Limited, Shenzhen (CN)

(72) Inventors: Wentao LIU, Shenzhen (CN); Yuhang WANG, Shenzhen (CN); Jue WANG, Shenzhen (CN); Kuifeng SU, Shenzhen (CN)

(73) Assignee: Tencent Technology (Shenzhen) Company Limited, Shenzhen (CN)

(21) Appl. No.: 18/331,540

(22) Filed: Jun. 8, 2023

Related U.S. Application Data
(63) Continuation of application No. PCT/CN2022/112479, filed on Aug. 15, 2022.

(30) Foreign Application Priority Data
Sep. 16, 2021 (CN) 202111088931.8

(51) Int. Cl. G08G 1/01

(52) U.S. Cl. CPC G08G 1/0145; G08G 1/0133

(57) ABSTRACT

A traffic flow migration situation display method and apparatus, a device and a medium, relating to the field of traffic analysis technologies. The method includes: obtaining a road network driving trajectory of a vehicle, the road network driving trajectory being composed of links in the road network; determining traffic flow migration data of a target region based on a spatial positional relationship between the road network driving trajectory and the target region, the traffic flow migration data including region-level traffic flow migration data and road-level traffic flow migration data, the region-level traffic flow migration data being used for representing a traffic inflow/outflow situation of the target region, and the road-level traffic flow migration data being used for representing a traffic inflow/outflow situation of a boundary link of the target region; and displaying a traffic flow migration situation of the target region based on the traffic flow migration data.

### RELATED APPLICATION

This application is a continuation of International Application PCT/CN2022/112479 filed on Aug. 15, 2022, which claims priority to Chinese Patent Application No. 202111088931.8, filed on Sep. 16, 2021 and entitled “TRAFFIC FLOW MIGRATION SITUATION DISPLAY METHOD AND APPARATUS, DEVICE, AND MEDIUM”. Both of these applications are incorporated herein by reference in their entirety.

### FIELD OF THE TECHNOLOGY

Embodiments of this application relate to the field of traffic analysis technologies, and in particular, to a traffic flow migration situation display method and apparatus, a device, a medium and a product.

### BACKGROUND OF THE DISCLOSURE

With the continuous expansion of the city and the explosive growth of the urban population, the urban infrastructure is difficult to meet the surge demand for a while, so it is particularly important to make a reasonable traffic planning based on the traffic facilities in the city.

To analyze the traffic flow migration situation between different regions, so as to carry out traffic planning based on the traffic flow migration situation, related technologies can determine the vehicle migration between regions based on positioning point data reported by vehicles. For example, based on the latitude and longitude coordinates of each vehicle, a departure region and an entry region of each vehicle are determined, so that the traffic flow migration data may be obtained statistically based on the departure regions and the entry regions of a large number of vehicles.

However, because the solution above can only analyze the traffic flow migration situation at the macro level, the utilization rate of the analysis results is relatively low.

### SUMMARY

Embodiments of this application provide a traffic flow migration situation display method and apparatus, a device, a medium and a product, which can realize the analysis of traffic flow migration situation at the macro level (region level) and micro level (road level), and improve the utilization rate of the analysis results. The technical solutions are as follows:

In one aspect, an embodiment of this application provides a traffic flow migration situation display method, executed by a computer device, the method including:
obtaining a road network driving trajectory of a vehicle, the road network driving trajectory being used for representing a trajectory generated by the vehicle traveling in a road network, and the road network driving trajectory being composed of links in the road network;
determining traffic flow migration data of a target region based on a spatial positional relationship between the road network driving trajectory and the target region, the traffic flow migration data including region-level traffic flow migration data and road-level traffic flow migration data, the region-level traffic flow migration data being used for representing a traffic inflow/outflow situation of the target region, and the road-level traffic flow migration data being used for representing a traffic inflow/outflow situation of a boundary link of the target region; and
displaying a traffic flow migration situation of the target region based on the traffic flow migration data.

In another aspect, an embodiment of this application provides a traffic flow migration situation display apparatus, including:
a first obtaining module, configured to obtain a road network driving trajectory of a vehicle, the road network driving trajectory being used for representing a trajectory generated by the vehicle traveling in a road network, and the road network driving trajectory being composed of links in the road network;
a first determining module, configured to determine traffic flow migration data of a target region based on a spatial positional relationship between the road network driving trajectory and the target region, the traffic flow migration data including region-level traffic flow migration data and road-level traffic flow migration data, the region-level traffic flow migration data being used for representing a traffic inflow/outflow situation of the target region, and the road-level traffic flow migration data being used for representing a traffic inflow/outflow situation of a boundary link of the target region; and
a displaying module, configured to display a traffic flow migration situation of the target region based on the traffic flow migration data.

In another aspect, an embodiment of this application provides a computer device, including a processor and a memory, the memory storing at least one instruction, and the at least one instruction being loaded and executed by the processor to implement the traffic flow migration situation display method as described in the foregoing aspect.

In another aspect, an embodiment of this application provides a computer-readable storage medium having at least one instruction stored therein, the instruction being loaded and executed by a processor to implement the traffic flow migration situation display method as described in the foregoing aspect.

In another aspect, an embodiment of this application provides a computer program product or a computer program. The computer program product or the computer program includes a computer instruction stored in a computer-readable storage medium. A processor of a computer device reads the computer instructions from the computer-readable storage medium. The processor executes the computer instructions, so that the computer device executes the traffic flow migration situation display method provided in the foregoing aspect.

In the embodiments of this application, in a case that the traffic flow migration analysis is performed on the target region, since the obtained road network driving trajectory of the vehicle is composed of links in the road network, in addition to determining the region-level traffic flow migration data at the macro level based on the spatial positional relationship between the road network driving trajectory and the target region, it is also possible to determine the road-level traffic flow migration data at the micro level that represents the traffic inflow/outflow situation of the boundary link. The data analysis dimension of traffic flow migration data is refined, which facilitates improving the utilization rate of traffic flow migration data. Moreover, compared with directly performing traffic flow migration analysis based on positioning point data of the vehicle in the related technology, performing the traffic flow migration analysis based on the road network driving trajectory mapped to the road network may avoid the problem of lower analysis accuracy caused by abnormal communication, positioning errors, and other reasons, improving the accuracy of the traffic flow migration data.

### BRIEF DESCRIPTION OF THE DRAWINGS

FIG. 1 is a schematic principal diagram according to an exemplary embodiment of this application.

FIG. 2 is a schematic diagram of an implement environment according to an exemplary embodiment of this application.

FIG. 3 is a flowchart of a traffic flow migration situation display method according to an exemplary embodiment of this application.

FIG. 4 is a schematic diagram of a region-level traffic flow migration situation display effect according to an exemplary embodiment of this application.

FIG. 5 is a schematic diagram of a road-level traffic flow migration situation display effect according to an exemplary embodiment of this application.

FIG. 6 is a flowchart of a process of generating a road network driving trajectory according to an embodiment of this application.

FIG. 7 is a schematic implementation diagram of a process of generating a road network driving trajectory according to an embodiment of this application.

FIG. 8 is a flowchart of a trajectory splicing process according to an exemplary embodiment of this application.

FIG. 9 is a flowchart of a process of determining region-level traffic flow migration data according to an exemplary embodiment of this application.

FIG. 10 is a schematic implementation diagram of a process of determining a spatial positional relationship between a trajectory endpoint and a region boundary according to an exemplary embodiment of this application.

FIG. 11 is a flowchart of a process of determining a spatial positional relationship between a trajectory endpoint and a target region according to an exemplary embodiment of this application.

FIG. 12 is a flowchart of a process of determining road-level traffic flow migration data according to an exemplary embodiment of this application.

FIG. 13 is a schematic implementation diagram of a process of determining a spatial positional relationship between a link and a region boundary according to an exemplary embodiment of this application.

FIG. 14 is a schematic diagram of a boundary link of a target region according to an exemplary embodiment of this application.

FIG. 15 is a schematic diagram of a candidate region division and selection process according to an exemplary embodiment of this application.

FIG. 16 is a schematic structural diagram of a computer device according to an exemplary embodiment of this application.

FIG. 17 is a structural block diagram of a traffic flow migration situation display apparatus according to an exemplary embodiment of this application.

### DESCRIPTION OF EMBODIMENTS

To facilitate understanding, the following explains terms involved in the embodiments of this application.

Origin Destination (OD): a movement of people, goods or vehicles from an origin to a destination is called a traffic trip, and OD refers to the traffic trip volume between the origin and the destination of the traffic trip.

Traffic flow migration: a process of a vehicle traveling in an urban road network, including traffic inflow (of a certain region) and traffic outflow (of a certain region). With the change of time, the positions of some vehicles change, and the position change of most vehicles shows a certain regularity as a whole. The purpose of traffic flow migration analysis is to determine the process of vehicle position change, and then carry out traffic planning in a targeted manner.

Road network: a road network in the transportation field for limiting movement trajectory of pedestrians and vehicles. The basic unit in the road network is a link, the length of the link is 10 m to 500 m, and the link is composed of an ordered coordinate sequence, with properties such as length, coordinates, and an origin point.

Region: a region in the embodiments of this application refers to a polygon region in the map, the polygon region may be a region divided according to an administrative block, a region divided according to a fixed block size, or a customized region, with attributes such as number and boundary coordinate point.

Boundary link: the region boundary is used for representing a boundary range of a specified region, while boundary link refers to a link of the road network that is spatially relative to region boundary. In general, a region includes a plurality of boundary links.

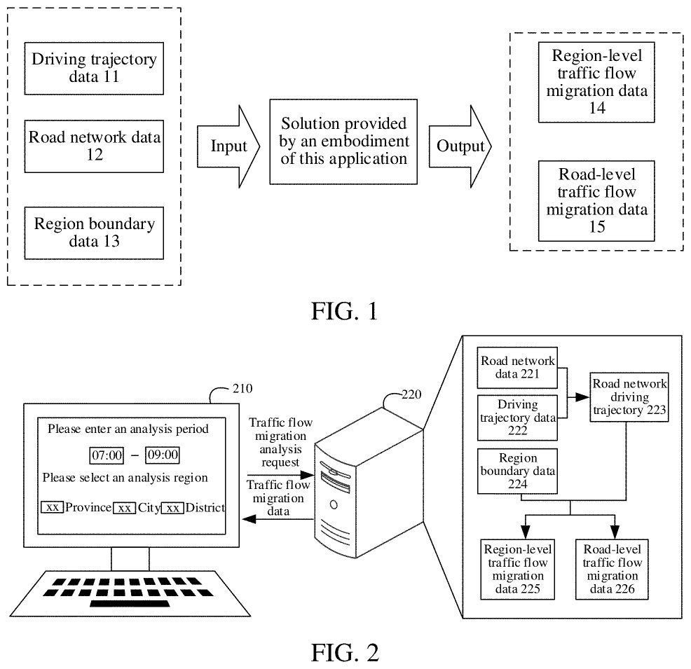

The solution provided by an embodiment of this application, as shown in FIG. 1, takes driving trajectory data 11 of a vehicle, road network data 12 of a basic road network, and region boundary data 13 of a target region (i.e., a region to be analyzed) as inputs, and macro-level region-level traffic flow migration data 14 of the target region, and micro-level road-level traffic flow migration data 15 may be obtained. By closely combining the driving trajectory data 11 and the road network data 12, a positioning point of the vehicle is matched to the link of the road network, and the driving situation of the vehicle in the road network is restored (that is, the road network driving trajectory of the vehicle is obtained), so that the region-level traffic flow migration data 14 is determined based on the road network driving trajectory and the region boundary data 13, and the boundary link of the target region is further analyzed to determine the road-level traffic flow migration data 15 of the boundary link, while realizing the integrated analysis at the macro and micro levels, which avoids the problem of lower analysis accuracy caused by positioning errors and other reasons, and improves the accuracy of traffic flow migration data.

FIG. 2 is a schematic diagram of an implementation environment according to an exemplary embodiment of this application. The implementation environment includes a terminal 210 and a server 220. The terminal 210 is in data communication with the server 220 through a communication network. Optionally, the communication network may be a wired network or a wireless network, and the communication network may be at least one of a local area network, a metropolitan area network, and a wide area network.

The terminal 210 is an electronic device that has the analysis requirements of the traffic flow migration situation. The electronic device may be a smart phone, a tablet computer or a personal computer, etc. In FIG. 2, the terminal 210 is illustrated by taking a personal computer used by traffic management personnel in the traffic road network command center as an example, but it is not limited thereto.

In some embodiments, the analysis requirements of the traffic flow migration situation may be aimed at a specified time period and a specified region, where the specified period is in hours, days or other durations, and the specified region may be a pre-divided region or a customized region, which is not limited in this embodiment. In a possible implementation, an application program with a traffic flow migration situation analysis function is installed in the terminal 210, and in a case that the traffic flow migration situation analysis is performed, the traffic management personnel promptly inputs a specified time period through the application program (such as 07:00 to 09:00 in FIG. 2), and selects a specified region to be analyzed (such as xx district, xx city, xx province in FIG. 2).

The server 220 may be an independent physical server, a server cluster or distributed system composed of multiple physical servers, and a cloud server providing basic cloud computing services, such as cloud services, cloud databases, cloud computing, cloud functions, cloud storage, network services, cloud communications, middleware services, domain name services, security services, Content Delivery Networks (CDN), big data and artificial intelligence platforms. In the embodiment of this application, the server 220 may be a server that provides analysis services for traffic flow migration situation, such as a background server of the traffic road network command center. Optionally, the server 220 may also be implemented as a node in a blockchain system.

In some embodiments, the server 220 stores road network data 221 of the basic road network. To facilitate subsequent integrated analysis at the macro and micro levels and improve the accuracy of analysis, after receiving the driving trajectory data 223 reported by vehicles, the server 220 matches the driving trajectory data 222 with the road network data 221 to generate road network driving trajectories 223 of vehicles, and store the road network driving trajectory 223 of each vehicle. In response to receiving a traffic flow migration analysis request from the terminal 210, the server 220 first screens a road network driving trajectory 223 within a specified time period according to the specified time period contained in the traffic flow migration analysis request, and then determines, according to a specified region indicated by the traffic flow migration analysis request, region-level traffic flow migration data 225 and road-level traffic flow migration data 226 of the specified region based on region boundary data 224 of the specified region and the screened road network driving trajectory 223, and then feeds the above data back to the terminal 210, so that the terminal 210 displays the traffic flow migration situation in the specified region.

Optionally, the above traffic flow migration data may provide a basis for subsequent traffic planning in addition to being used for visually displaying the traffic flow migration situation of the specified region. For example, based on the road-level traffic flow migration data, the traffic management personnel may determine entering or leaving a high-frequency boundary link of the specified region, and only perform traffic control or diversion on the high-frequency boundary link to avoid congestion on the high-frequency boundary link.

In other possible implementations, the process of generating road network driving trajectories and the process of analyzing the traffic flow migration situation may also be executed by the terminal without using a server. For the convenience of description, the following embodiments are illustrated by taking the traffic flow migration situation display method being executed by a computer device as an example.

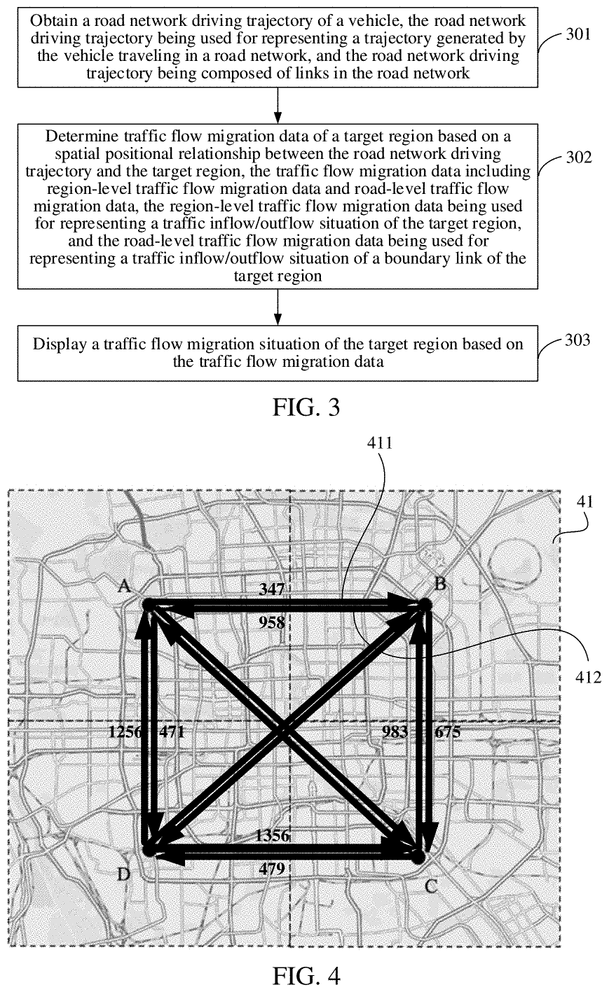

FIG. 3 is a flowchart of a traffic flow migration situation display method according to an exemplary embodiment of this application. This embodiment describes by taking the method being used in a computer device as an example. The method includes the following steps:

Step 301: Obtain a road network driving trajectory of a vehicle, the road network driving trajectory being used for representing a trajectory generated by the vehicle traveling in a road network, and the road network driving trajectory being composed of links in the road network.

Optionally, the road network driving trajectory is generated and stored by a computer device in advance based on driving trajectory data and road network data reported by a vehicle. In response to receiving a traffic flow migration analysis request or a vehicle migration analysis instruction, the computer device obtains the stored road network driving trajectory.

The road network driving trajectory in this embodiment is a complete trajectory of the vehicle from the origin to the destination, and the road network driving trajectory is composed of several links in the road network, that is, a road network driving trajectory may be regarded as a link set composed of several links, rather than data composed of discrete positioning points separated from the road network data. There is a cohesive relationship between the links constituting a trajectory in the form of a road network, that is, among several links, there is at least a connection between one link a and another link b.

Optionally, the links in the road network are provided with corresponding link identifiers, and the road network driving trajectory is represented by a link identifier set. For example, a link driving trajectory is {link001, link002, link003}, which indicates that the link driving trajectory is composed of a link marked as “link001”, a link marked as “link002” and a link marked as “link003” in the road network.

In a possible implementation, the road network driving trajectory also includes corresponding travel time, in a case that the received traffic flow migration analysis instruction contains a specified time period, that is, in a case that the traffic flow migration situation in the specified region within the specified time period is indicated to be analyzed, the computer device screens the road network driving trajectory with the travel time within a specified time period from the stored road network driving trajectories for subsequent traffic flow migration analysis.

Step 302: Determine traffic flow migration data of a target region based on a spatial positional relationship between the road network driving trajectory and the target region, the traffic flow migration data including region-level traffic flow migration data and road-level traffic flow migration data, the region-level traffic flow migration data being used for representing a traffic inflow/outflow situation of the target region, and the road-level traffic flow migration data being used for representing a traffic inflow/outflow situation of a boundary link of the target region.

The target region is a specified region where the traffic flow migration situation is to be analyzed, and there is at least one target region. Optionally, the target region is a pre-divided candidate region, or the target region is a customized region in the map, such as a polygonal region manually selected in the map.

To determine the spatial positional relationship between the road network driving trajectory and the target region, the computer device needs to obtain region boundary data of the target region, so as to determine the spatial positional relationship between the road network driving trajectory and the region boundary of the target region based on the region boundary data, and then determine the traffic flow migration data.

In some embodiments, the region boundary data may be each boundary coordinate point in the target region, and based on two adjacent boundary coordinate points, the computer device may determine the region boundary of the target region.

In some embodiments, in a case that the traffic flow migration analysis is performed on the target region, the determined region-level traffic flow migration data includes traffic inflow data and the traffic outflow data of the target region. In a case that traffic flow migration analysis is performed on a plurality of target regions, the determined region-level traffic flow migration data may not only include the traffic inflow data and the traffic outflow data of each target region, but also include traffic inflow data and traffic outflow data between the target regions, such as traffic flow data moving out of a first target region and moving into a second target region.

Because the road network driving trajectory matches the road network, compared with determining the region-level traffic flow migration data directly based on the vehicle's positioning point data, the region-level traffic flow migration data determined based on the spatial positional relationship between the road network driving trajectory and the target region has higher accuracy (especially for the road network driving trajectories located at the region boundary).

Moreover, since the road network driving trajectory is composed of links in the road network, in addition to determining the region-level traffic flow migration data, the computer device may also implement a more fine-grained analysis of the traffic flow migration situation, i.e., determine the road-level traffic flow migration data of the boundary link of the target region. In some embodiments, the determined road-level traffic flow migration data includes traffic inflow data and traffic outflow data of each boundary link in each target region. The number of boundary links corresponding to different target regions may be different, and the boundary links corresponding to adjacent target regions may be repeated. Schematically, a target region 1 and a target region 2 are adjacent to each other, and the target region 1 enters the target region 2 through a link a. The target region 2 enters the target region 1 through a link a′, then data that the target region 1 moves out of the target region 2 through the link a is duplicated with data that the target region 2 moves in through the link a′.

Step 303: Display a traffic flow migration situation of the target region based on the traffic flow migration data.

Furthermore, the computer device displays the traffic flow migration situation of the target region based on the traffic flow migration data. In a possible implementation, in a case that the computer device has a display function, the computer device displays the traffic flow migration situation of the target region on the map. In a case that the computer device does not have the display function, the computer device sends the traffic flow migration data to a device having the display function for display.

Optionally, the computer device displays the region-level traffic flow migration situation of the target region based on the region-level traffic flow migration data, and displays the road-level traffic flow migration situation of the target region based on the road-level traffic flow migration data. Optionally, the display forms of the region-level traffic flow migration situation and the road-level traffic flow migration situation are different.

In a possible implementation, in a case that the region-level traffic flow migration situation of the target region is displayed based on the region-level traffic flow migration data, the computer device generates a traffic inflow identifier and a traffic outflow identifier based on the region-level traffic flow migration data, and displays the traffic inflow identifier and the traffic outflow identifier in a display region corresponding to the target region. Optionally, the traffic inflow identifier is an arrow pointing from an outflow region to the target region and containing the traffic inflow data. The traffic outflow identifier is an arrow pointing from the target region to an inflow region and containing the traffic outflow data. This embodiment does not limit the specific expression forms of the traffic inflow identifier and the traffic outflow identifier. Optionally, data used for representing the number of vehicles moving in is displayed in the traffic inflow identifier. data used for representing the number of vehicles moving out is displayed in the traffic outflow identifier.

Schematically, as shown in FIG. 4, after analyzing the region-level traffic flow migration situation in four regions A, B, C, and D, the computer device displays a traffic outflow identifier 411 and a traffic inflow identifier 412 between the region A and the region B in an electronic map 41. The traffic outflow identifier 411 indicates that a total of 347 vehicles move from the region A to the region B, and the traffic inflow identifier 412 indicates that a total of 958 vehicles move from the region B to the region A.

In a possible implementation, in a case that the road-level traffic flow migration situation of the target region is displayed based on the road-level traffic flow migration data, the computer device highlights the boundary link of the target region in the map based on the road-level traffic flow migration data.

Optionally, in order to indicate the traffic flow of different boundary links, the boundary links with different traffic inflow/outflow situations correspond to different display modes. For example, a thickness of the boundary link is in a positive correlation relationship with a data volume of traffic inflow/outflow data, that is, the more the traffic inflow/outflow on the boundary link is, the thicker the boundary link is. Alternatively, a color of the boundary link corresponds to a data volume of traffic inflow/outflow, such as: the more the traffic inflow/outflow on the boundary link is, the redder the color displayed on the boundary link is. Alternatively, a line segment style of the boundary link corresponds to a data volume of the traffic inflow/outflow data, such as: the more the traffic inflow/outflow on the boundary link is, the more the line segment style of the boundary linker is closer to a solid line, otherwise, the more it is closer to be a dashed line.

Furthermore, in response to a selection operation of a target boundary link, the computer device displays the road-level traffic flow migration data corresponding to the target boundary link, so that a user knows the specific traffic flow of each boundary link.

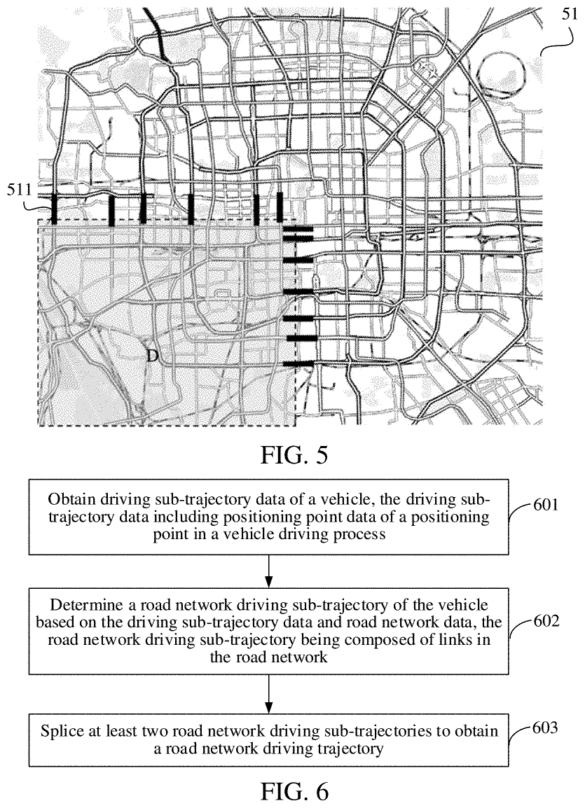

Schematically, as shown in FIG. 5, after analyzing the road-level traffic flow migration situation in the region D, the computer device displays in bold a boundary link 511 in the region D in an electronic map 51, and in a case that the user selects a certain boundary link 511, the computer device displays the number of incoming vehicles and the number of outgoing vehicles passing through the boundary link 511.

Certainly, in other possible implementations, the computer device may also directly display the traffic flow migration data in a form such as a table, which is not limited in this embodiment.

In conclusion, in the embodiment of this application, in a case that the traffic flow migration analysis is performed on the target region, since the obtained road network driving trajectory of the vehicle is composed of links in the road network, in addition to determining the region-level traffic flow migration data at the macro level based on the spatial positional relationship between the road network driving trajectory and the target region, it is also possible to determine the road-level traffic flow migration data at the micro level that represents the traffic inflow/outflow situation of the boundary link. The data analysis dimension of traffic flow migration data is refined, which facilitates improving the utilization rate of traffic flow migration data. Moreover, compared with directly performing traffic flow migration analysis based on positioning point data of the vehicle in the related technology, performing the traffic flow migration analysis based on the road network driving trajectory mapped to the road network may avoid the problem of lower analysis accuracy caused by abnormal communication, positioning errors, and other reasons, further improving the accuracy of the traffic flow migration data.

The method provided in this embodiment improves the display intuitiveness of the traffic flow migration data and improves the efficiency of human-computer interaction by displaying the traffic inflow identifier and the traffic outflow identifier.

The method provided in this embodiment displays the link in different forms according to the traffic inflow/outflow situation, and may intuitively reflect the traffic flow situation of the link through the performance display, which improves the display efficiency.

In the embodiment of this application, since a road network driving trajectory matching the road network needs to be used during analysis of the traffic flow migration situation, and the driving trajectory data reported by the vehicle is not matched with the road network, the computer device first needs to perform preprocessing on the driving trajectory data to obtain a complete traffic trip correspondence. The process of data preprocessing is described below.

FIG. 6 is a flowchart of a process of generating a road network driving trajectory according to an embodiment of this application. The process may include the following steps:

Step 601: Obtain driving sub-trajectory data of a vehicle, the driving sub-trajectory data including positioning point data of a positioning point in a vehicle driving process.

In a possible implementation, a vehicle-mounted terminal (such as a head unit or a mobile terminal with a navigation function enabled) is provided with a positioning assembly. During driving, the positioning assembly locates the current position of the vehicle at a preset interval to obtain positioning point data of continuous positioning points. Optionally, the positioning point data includes at least longitude and latitude coordinates of the positioning point and a positioning time.

During a complete driving process, the vehicle may stop halfway, such as waiting at a traffic light intersection and stopping at a gas station to refuel, and in a case that the vehicle-mounted terminal detects that the vehicle's position has not changed for a period of time, the positioning point data is packaged for reporting, and correspondingly, the computer device obtains driving sub-trajectory data corresponding to several segments of the driving sub-trajectory in the complete driving trajectory.

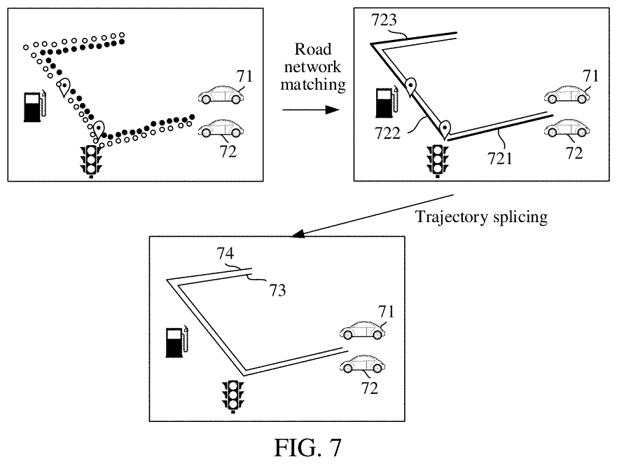

Schematically, as shown in FIG. 7, the origin and destination of a first vehicle 71 are the same as those of a second vehicle 72. The first vehicle 71 does not stop during the driving process, while the second vehicle 72 stops in response to traveling to a traffic light, and stops in response to traveling to a gas station. Therefore, the vehicle-mounted terminal of the second vehicle 72 reports three segments of driving sub-trajectory data, which are respectively first driving sub-trajectory data including positioning point data corresponding to the positioning point from the origin to the traffic light, second driving sub-trajectory data including positioning point data corresponding to the positioning point from the traffic light to the gas station, and third driving sub-trajectory data including positioning point data corresponding to the positioning point from the gas station to the destination.

Step 602: Determine a road network driving sub-trajectory of the vehicle based on the driving sub-trajectory data and road network data, the road network driving sub-trajectory being composed of links in the road network.

For the driving sub-trajectory data corresponding to each segment of the driving sub-trajectory, the computer device performs road network matching on the driving sub-trajectory data and the road network data, that is, matching each positioning point to the link in the road network, so as to determine the road network driving sub-trajectory of the vehicle. The road network driving sub-trajectory is also composed of links in the road network.

Regarding the specific mode of road network matching, in a possible implementation, the computer device matches the positioning point to the link in the road network based on the positioning point data and the link data of the link in the road network data, so as to generate the road network driving sub-trajectory based on the matched link. Optionally, the computer device matches the positioning point to the link in the road network through a hidden Markov model.

The positioning point data includes positioning point coordinates, and the link data includes origin coordinates of the link. Based on the positioning point coordinates and the origin coordinates, the computer device may calculate a distance between the positioning point and the link.

For a positioning point, there is a group of candidate links within a certain distance, and each candidate link is represented as a vertex with an observed state probability in a Markov chain. In a case that the positioning point is closer to the candidate link or a distance between two adjacent positioning points is relatively short, the candidate link has a higher probability value. The computer device calculates weights for edges connecting each pair of adjacent vertexes in the Markov chain, namely, a state transition probability, so that a maximum likelihood path with the highest observed state probability and state transition probability is determined as a road network driving sub-trajectory matching the driving sub-trajectory data.

Certainly, in addition to using the hidden Markov model for road network matching, the computer device may also use other methods for road network matching, such as directly matching the positioning point to the nearest link (the matching accuracy is relatively low), which is not limited in this embodiment.

Schematically, as shown in FIG. 7, the computer device performs road network matching on the driving sub-trajectory data corresponding to the second vehicle 72, to obtain a first road network driving sub-trajectory 721, a second road network driving sub-trajectory 722, and a third road network driving sub-trajectory 723.

In a possible implementation, for each determined segment of the road network driving sub-trajectory, the computer device performs associative storage on the road network driving sub-trajectory and a vehicle identifier, and determines a start time and an end time of the road network driving sub-trajectory based on the positioning time contained in the positioning point data.

Step 603: Splice at least two road network driving sub-trajectories to obtain the road network driving trajectory.

During vehicle migration analysis, it is necessary to combine a complete journey of the vehicle, so the computer device needs to splice the road network driving sub-trajectories of the same vehicle to obtain a road network driving trajectory corresponding to the complete journey. In general, in a complete journey, a duration of the stopover of the vehicle is usually short, so the computer device may perform sub-trajectory splicing based on an interval between the road network driving sub-trajectories. Optionally, this step may include the following sub-steps:

1: Obtain an end time of an i^{th} road network driving sub-trajectory, and a start time of an (i+1)^{th} road network driving sub-trajectory, i being a positive integer.

In a possible implementation, the computer device sorts the road network driving sub-trajectories in an ascending order based on the start time of the road network driving sub-trajectories. After sorting, the computer device traverses the road network driving sub-trajectories in sequence. In response to determining whether two adjacent road network driving sub-trajectories belong to a same road network driving trajectory, the computer device obtains an end time of an i^{th} road network driving sub-trajectory and a start time of an (i+1)^{th} road network driving sub-trajectory, and calculates a time interval between the end time and the start time. Furthermore, the computer device detects whether the time interval is greater than a threshold. If the time interval is less than or equal to the threshold, then it is determined that the i^{th} road network driving sub-trajectory and the (i+1)^{th} road network driving sub-trajectory belong to the same road network driving trajectory. If the time interval is greater than the threshold, it is determined that the i^{th} road network driving sub-trajectory and the (i+1)^{th} road network driving sub-trajectory belong to different road network driving trajectories.

For example, the threshold may be 30 min, and the threshold may be customized, which is not limited in this embodiment.

Schematically, as shown in FIG. 7, the computer device calculates a time interval between an end time of the first road network driving sub-trajectory 721 and a start time of the second road network driving sub-trajectory 722, and calculates a time interval between an end time of the second road network driving sub-trajectory 722 and a start time of the third road network driving sub-trajectory 723.

2: Splice the i^{th} road network driving sub-trajectory and the (i+1)^{th} road network driving sub-trajectory in response to a time interval between the end time and the start time being less than or equal to a threshold.

In a case that the time interval is less than or equal to the threshold, the computer device splices a trajectory origin of the (i+1)^{th} road network driving sub-trajectory behind a trajectory destination of the i^{th} road network driving sub-trajectory. Furthermore, the computer device traverses an (i+2)^{th} road network driving sub-trajectory, and determines whether the (i+2)^{th} road network driving sub-trajectory and the (i+1)^{th} road network driving sub-trajectory belong to the same road network driving trajectory.

In a possible implementation, the computer device adds a link identifier of a link corresponding to the (i+1)^{th} road network driving sub-trajectory to a link list corresponding to the road network driving trajectory obtained by splicing, and determines the end time of the (i+1)^{th} road network driving sub-trajectory as an end time of the spliced road network driving trajectory.

Schematically, as shown in FIG. 7, since the time interval between the end time of the first road network driving sub-trajectory 721 and the start time of the second road network driving sub-trajectory 722 is less than 30 min, the computer device splices the first road network driving sub-trajectory 721 and the second road network driving sub-trajectory 722. Since the time interval between the end time of the second road network driving sub-trajectory 722 and the start time of the third road network driving sub-trajectory 723 is less than 30 min, the computer device splices the second road network driving sub-trajectory 722 and the third road network driving sub-trajectory 723.

3: Output the spliced road network driving trajectory in response to the time interval between the end time and the start time being greater than threshold.

In a case that the time interval is greater than the threshold, it is indicated that the i^{th} road network driving sub-trajectory and the (i+1)^{th} road network driving sub-trajectory belong to different road network driving trajectories, so as to output a road network driving trajectory obtained by splicing the i^{th} road network driving sub-trajectory and previous road network driving sub-trajectory, and the (i+1)^{th} road network driving sub-trajectory is used as an initial sub-trajectory of the next road network driving trajectory.

Schematically, as shown in FIG. 7, the computer device splices the first road network driving sub-trajectory 721, the second road network driving sub-trajectory 722, and the third road network driving sub-trajectory 723 to obtain a second road network driving trajectory 74 corresponding to the second vehicle 72. The second road network driving trajectory 74 is consistent with the first road network driving trajectory 73 corresponding to the first vehicle 71.

In this embodiment, the computer device performs road network matching on the driving sub-trajectory data and the road network data to obtain several road network driving sub-trajectories, and splices, based on the start time and the end time of the sub-trajectories, the sub-trajectories to obtain a road network driving trajectory corresponding to the complete journey, which facilitates improving the accuracy of subsequent traffic flow migration analysis.

In the method provided in this embodiment, in a case that an interval between an end time of the i^{th} road network driving sub-trajectory and a start time of the (i+1)^{th} road network driving sub-trajectory is less than the threshold, it is indicated that an (i+1)^{th} road network travel time is a driving stage after an i^{th} road network travel time, so as to splice the road network driving sub-trajectories, thereby improving the acquisition efficiency and accuracy of road network driving trajectory data.

The method provided in this embodiment matches the positioning point to the link through the hidden Markov model, to obtain the road network driving sub-trajectory, and the link matching efficiency and accuracy are improved through a proximity algorithm.

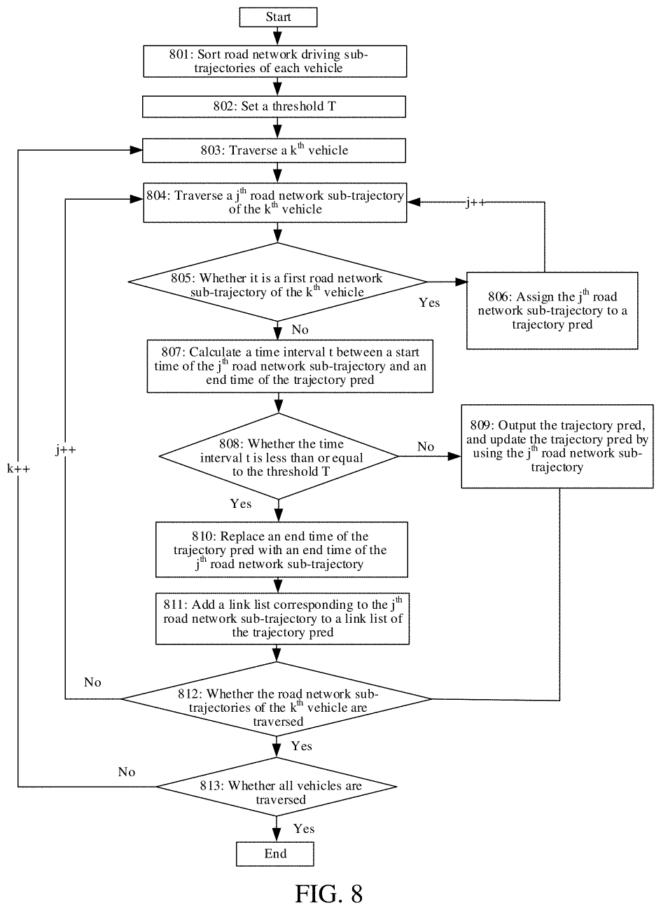

Since the computer device stores road network driving sub-trajectories corresponding to different vehicles, in a possible implementation, the process of the computer device determining the road network driving trajectories corresponding to different vehicles is as shown in FIG. 8. The process includes the following steps:

Step 801: Sort road network driving sub-trajectories of each vehicle.

Optionally, the road network driving sub-trajectories are sorted based on the start time of the road network driving sub-trajectories. The road network driving sub-trajectories are sorted in an ascending order according to the start time.

Step 802: Set a threshold T.

Optionally, the threshold T is a time interval threshold for controlling time interval requirements between adjacent road network driving sub-trajectories.

Step 803: Traverse a k^{th} vehicle.

That is, the road network driving sub-trajectories of the k^{th} vehicle are traversed to construct a road network driving trajectory of the k^{th} vehicle.

Step 804: Traverse a j^{th} road network sub-trajectory of the k^{th} vehicle.

Each road network driving sub-trajectory of the k^{th} vehicle is obtained, including the j^{th} road network driving sub-trajectory.

Step 805: Whether it is a first road network sub-trajectory of the k^{th} vehicle; if Yes, perform step 806; and if No, perform step 807.

Step 806: Assign the j^{th} road network sub-trajectory to a trajectory pred; j++(i.e., performing an add-one operation).

If the j^{th} road network sub-trajectory is a first road network sub-trajectory of the k^{th} vehicle, the j^{th} road network sub-trajectory is assigned and stored.

Step 807: Calculate a time interval t between a start time of the j^{th} road network sub-trajectory and an end time of the trajectory pred.

The trajectory pred is the stored road network sub-trajectory of the k^{th} vehicle, and a time interval between the j^{th} road network sub-trajectory and an end time of the last stored road network sub-trajectory is determined, so as to determine whether the j^{th} road network sub-trajectory may be used as a next stored road network sub-trajectory.

Step 808: Whether the time interval t is less than or equal to the threshold T; if less than or equal to, perform step 810, if greater than, perform step 809.

Step 809: Output the trajectory pred, and update the trajectory pred by using the j^{th} road network sub-trajectory.

If the time interval t is greater than the time threshold T, it is indicated that the road network driving trajectory stays before the j^{th} road network sub-trajectory, so the stored trajectory pred is first output, and the trajectory pred is cleared, and the j^{th} road network sub-trajectory is used as a first road network sub-trajectory of the updated pred.

Step 810: Replace an end time of the trajectory pred with an end time of the j^{th} road network sub-trajectory.

The end time of the j^{th} road network sub-trajectory is used as the end time of the updated current trajectory pred.

Step 811: Add a link list corresponding to the j^{th} road network sub-trajectory to the link list of the trajectory pred.

Step 812: Whether the road network sub-trajectories of the k^{th} vehicle are traversed; if no, j++, and perform step 804; and if yes, perform step 813.

Step 813: Whether all vehicles are traversed; if no, k++, and perform step 803; and if yes, end.

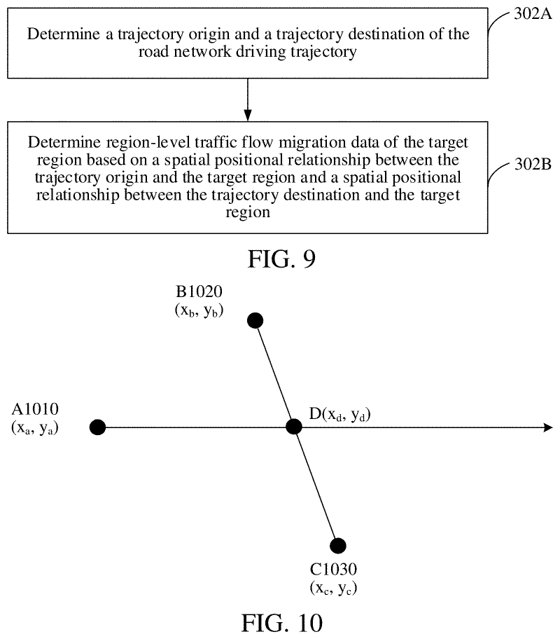

After the road network driving trajectory of the vehicle is generated through the above steps, the computer device may further determine the origin and destination of the road network driving trajectory, and determine the region-level traffic flow migration data based on a spatial positional relationship between the origin and destination and the target region. In a possible implementation, as shown in FIG. 9, step 302 may include the following steps:

Step 302A: Determine a trajectory origin and a trajectory destination of the road network driving trajectory.

In some embodiments, both the trajectory origin and the trajectory destination are represented by latitude and longitude coordinates.

In a possible implementation, the computer device extracts the positioning point coordinates corresponding to the initial positioning point of the road network driving trajectory as the trajectory origin, and extracts the positioning point coordinates corresponding to the end positioning point of the road network driving trajectory as the trajectory destination.

In another possible implementation, in order to reduce the impact of positioning accuracy on analysis accuracy, after the computer device extracts the positioning point coordinates of the initial positioning point and the end positioning point, the positioning point coordinates may be mapped to a link corresponding to the road network driving trajectory, so that the mapping points on the link are determined as the trajectory origin and the trajectory destination.

Certainly, the computer device may also determine the trajectory origin and the trajectory destination in other ways, which is not limited in this embodiment.

Step 302B: Determine the region-level traffic flow migration data of the target region based on a spatial positional relationship between the trajectory origin and the target region and a spatial positional relationship between the trajectory destination and the target region.

The spatial positional relationship between the trajectory origin (or the trajectory destination) and the target region includes being located inside the target region and being located outside the target region. Moreover, in general, in a case that the vehicle leaves the target region, the trajectory origin of the road network driving trajectory is located in the target region, and the trajectory destination is located in other regions. In a case that the vehicle enters the target region, the trajectory origin of the road network driving trajectory is located in other regions, and the trajectory destination is located in the target region. Optionally, this step includes the following sub-steps:

1: Update traffic outflow data of the target region in response to the trajectory origin being within the target region and the trajectory destination being outside the target region.

Regarding the mode of determining whether the trajectory origin (or the trajectory destination) is located in the target region, in a possible implementation, the computer device determines each region boundary of the target region, and uses the trajectory origin (or the trajectory destination) as an endpoint to generate a ray in a given direction, so as to determine whether the trajectory origin (or trajectory destination) is located in the target region based on the intersection of the ray with each region boundary. The region boundary is determined based on the boundary coordinate points of the target region.

In response to the number of region boundaries intersected with the ray being an odd number, it is determined that the trajectory origin (or the trajectory destination) is located in the target region. In response to the number of region boundaries intersected with the ray being an even number, it is determined that the trajectory origin (or the trajectory destination) is located outside the target region.

Schematically, as shown in FIG. 10, the coordinates of a trajectory origin A1010 are (xₐ, yₐ), the boundary coordinates B1020 of the region boundary BC in the target region are (x_{b}, y_{b}), and the boundary coordinates C1030 are (x_{c}, y_{c}). The trajectory origin A1010 is an endpoint. After a transverse ray is generated, in response to the ray intersecting the region boundary BC, the following formula has a solution. In response to the ray not intersecting the region boundary BC, the following formula has no solution.

$${x}_{d} = {x}_{c} + \frac{{y}_{a} - {y}_{c}}{{y}_{b} - {y}_{c}} ( {x}_{b} - {x}_{c} )$$

Although this embodiment only takes the above mode of determining the positional relationship between the point and the polygonal region as an example for schematic illustration, but it is not limited thereto.

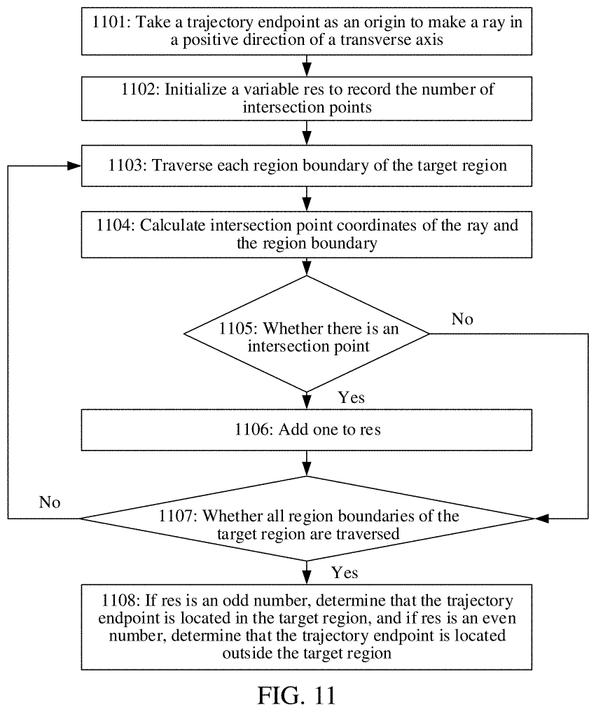

In a schematic example, the computer device determines the positional relationship between the trajectory endpoint and the target region, as shown in FIG. 11.

Step 1101: Take the trajectory endpoint as an origin to make a ray in the positive direction of a transverse axis.

Optionally, the map is annotated with a preset coordinate system, which includes a transverse axis and a longitudinal axis. A ray is drawn along the positive direction of the transverse axis with the trajectory endpoint as the origin, so as to determine the region boundary intersecting the ray.

Step 1102: Initialize a variable res to record the number of intersection points.

The variable res is used for representing the number of points where the current ray made with the trajectory endpoint as the origin intersects the region boundary.

Step 1103: Traverse each region boundary of the target region.

That is, whether each region boundary of the target region is ray-intersected is determined.

Step 1104: Calculate the intersection point coordinates of the ray and the region boundary;
if intersecting, calculate and record the coordinates of the intersection point of the ray and the region boundary.

Step 1105: Whether there is an intersection point; if yes, then perform step 1106; and if not, then perform step 1107.

Step 1106: Add one to res.

Adding one to res indicates adding one to the number of intersection points intersected with the ray.

Step 1107: Whether all region boundaries of the target region are traversed; if Yes, perform step 1108; and if No, perform step 1103.

Step 1108: If res is an odd number, determine that the trajectory endpoint is located in the target region, and if res is an even number, determine that the trajectory endpoint is located outside the target region.

Optionally, in a case that res is an odd number, it is indicated that in the positive direction of the transverse axis, the ray only intersects with one or an odd number of region boundaries of the target region, and if it enters from one boundary and exits from another boundary, two intersection points may inevitably occur. Therefore, odd res is used for representing that the trajectory endpoint is located in the target region, otherwise, the trajectory endpoint is located outside the target region.

In response to determining that the trajectory origin is located in the target region and the trajectory destination is located outside the target region, the computer device determines that in a case of traveling along the road network driving trajectory, the vehicle may leave the target region, so as to update the traffic outflow data of the target region, i.e., adding one to the traffic outflow data.

2: Update traffic inflow data of the target region in response to the trajectory origin being outside the target region and the trajectory destination being within the target region.

In response to determining that the trajectory origin is located outside the target region and the trajectory destination is located in the target region, the computer device determines that in a case of traveling along the road network driving trajectory, the vehicle may drive into the target region, so as to update the traffic inflow data of the target region, i.e., adding one to the traffic inflow data.

3: Determine the traffic outflow data of the target region and the traffic inflow data of the target region as the region-level traffic flow migration data.

Furthermore, after traversing each road network driving trajectory, the computer device determines the traffic outflow/inflow data of the target region as the region-level traffic flow migration data.

In a possible implementation, in a case that an electronic map is pre-divided into several regions, through the above steps, the computer device may determine the outflow region corresponding to the trajectory origin and the inflow region corresponding to the trajectory destination, so as to generate correspondences among the road network driving trajectory, the inflow region, and the outflow region. Schematically, the correspondences are as shown in Table 1.

TABLE 1

| Road network | | |
|---|---|---|
| driving trajectory | Outflow region | Inflow region |
| t₁ | a₁₁ | a₁₂ |
| t₂ | a₂₁ | a₂₂ |
| . . . | . . . | . . . |
| tₘ | aₘ₁ | aₘ₂ |

Furthermore, based on the above correspondences, the computer device may collect statistics about the traffic inflow/outflow data between the regions. In a schematic example, the electronic map is divided into nine regions of ABCDEFGHI, and the traffic inflow/outflow data between the regions are as shown in Table 2.

TABLE 2

| | A | B | C | D | E | F | G | H | I |
|---|---|---|---|---|---|---|---|---|---|
| A | v₁₁ | v₁₂ | v₁₃ | . . . | . . . | . . . | . . . | v₁₈ | v₁₉ |
| B | v₂₁ | v₂₂ | v₂₃ | . . . | . . . | . . . | . . . | v₂₈ | v₂₉ |
| C | . . . | . . . | . . . | . . . | . . . | . . . | . . . | . . . | . . . |
| D | . . . | . . . | . . . | . . . | . . . | . . . | . . . | . . . | . . . |
| E | . . . | . . . | . . . | . . . | . . . | . . . | . . . | . . . | . . . |
| F | . . . | . . . | . . . | . . . | . . . | . . . | . . . | . . . | . . . |
| G | . . . | . . . | . . . | . . . | . . . | . . . | . . . | . . . | . . . |
| H | v₈₁ | v₈₂ | v₈₃ | . . . | . . . | . . . | . . . | v₈₈ | v₈₉ |
| I | v₉₁ | v₉₂ | v₉₃ | . . . | . . . | . . . | . . . | v₉₈ | v₉₉ |

v_{xy} represents the number of vehicles moving out of a region x and moving into a region y, and a value of a main diagonal element in the table is 0 (that is, the case of not leaving the region is ignored).

Furthermore, the computer device may accumulate row data in the table to obtain vehicle outflow data in the region, and accumulate column data in the table to obtain the vehicle inflow data in the region.

The method provided in this embodiment determines whether the trajectory crosses the target region according to the spatial positional relationship between the trajectory origin and the trajectory destination and the target region, thereby improving the data processing efficiency.

In the method provided in this embodiment, in a case that one of the trajectory origin and the trajectory destination is located in the target region and the other is located outside the target region, it is determined that the trajectory crosses the target region, and the mode of determining the spatial relationship is relatively convenient, which improves the processing efficiency.

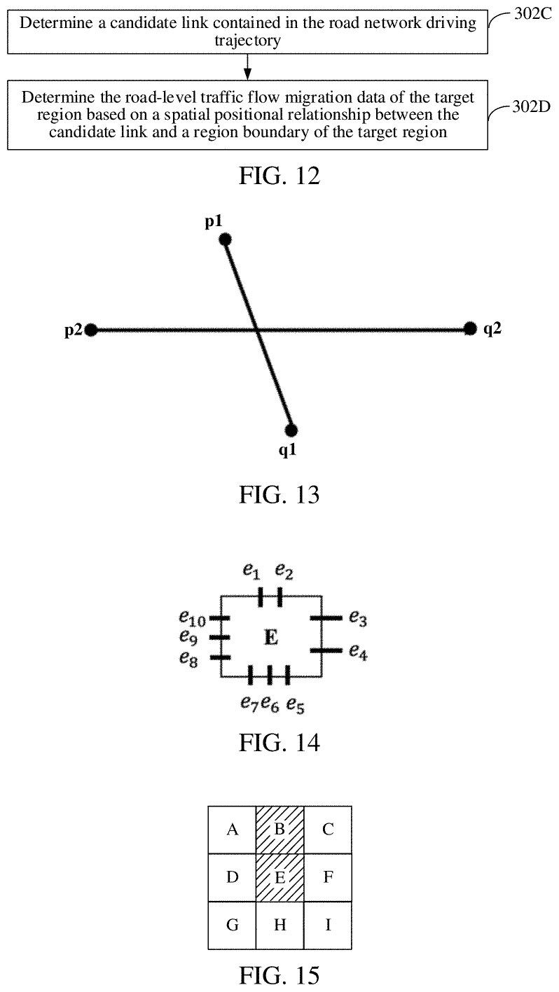

After determining the inflow region and the outflow region corresponding to the road network driving trajectory through the above steps, the computer device may further determine a boundary link passed when entering the inflow region and a boundary link passed when leaving the outflow region based on the spatial positional relationship between each link in the road network driving trajectory and the inflow region and the outflow region, so as to obtain the road-level traffic flow migration data. In a possible implementation, as shown in FIG. 12, step 302 may also include the following steps:

Step 302C: Determine a candidate link contained in the road network driving trajectory.

In a process of generating road network driving trajectories, the computer device generates a link list corresponding to each road network driving trajectory, and in response to performing road-level traffic flow migration analysis, the computer device determines candidate links included in the road network driving trajectory based on the link list.

Schematically, the computer device determines that the candidate links included in the road network driving trajectory are link001, link002, and link003 based on the link list corresponding to the road network driving trajectory.

Step 302D: Determine the road-level traffic flow migration data of the target region based on a spatial positional relationship between the candidate link and a region boundary of the target region.

Since the road-level traffic flow migration data is used for indicating the region boundary passed when moving into and out of the region, the computer device needs to traverse each candidate link in the road network driving trajectory to determine the spatial positional relationship between each candidate link and the corresponding region boundary of the target region, so as to determine a boundary link that is located in the target region where the vehicle moves in or out. Optionally, this step may include the following sub-steps:

1: Determine the candidate link intersecting the region boundary as the boundary link.

In a possible implementation, the computer device determines each region boundary of the target region based on the boundary vertexes of the target region, such as determining a region boundary according to two adjacent boundary vertexes, so as to determine whether the candidate link intersects each region boundary, and then determine the intersecting candidate link as the boundary link of the target region.

In some embodiments, since the computer device stores the coordinates of the origin and destination of each link in the road network, as well as the boundary coordinate points of the region, the computer device determines a first line segment based on a link coordinate origin and a link coordinate destination of the candidate link, and determine a second line segment based on a first boundary coordinate point and a second boundary coordinate point of the region boundary. In response to the first line segment intersecting with the second line segment, the computer device determines that the candidate link is a boundary link. In response to the first line segment not intersecting with the second line segment, the computer device determines that the candidate link does not belong to the boundary link, that is, the candidate link is no longer within the analysis range of the road-level traffic flow migration situation.

Regarding the mode of determining whether two line segments intersect, optionally, the computer device selects three endpoints from four endpoints of the first line segment and the second line segment, and determines a direction of the three endpoints at the spatial location (a clockwise direction, a counterclockwise direction or a collinear direction), so as to determine the comparison of the line segments according to corresponding directions of different endpoint combinations.

In some embodiments, two endpoints of the first line segment are p1 and p2, respectively (corresponding to the link origin and the link destination, respectively), and two destinations of the second line segment are q1 and q2, respectively (corresponding to two side coordinates, respectively). In response to the directions formed by (p1, q1, p2) and (p1, q1, q2) being different, and the directions formed by (p2, q2, p1) and (p2, q2, q1) being different, the computer device may further determine whether p1, p2, q1, and q2 are collinear. In response to p1, p2, q1, and q2 being not collinear, it is determined that the first line segment and the second line segment intersect. In response to p1, p2, q1, and q2 being collinear, and an intersection existing between projections of (p1, q1) and (p2, q2) on the transverse or longitudinal axis, then it is determined that the first line segment and the second line segment intersect.

Schematically, as shown in FIG. 13, since (p1, q1, p2) is clockwise, (p1, q1, q2) is counterclockwise, (p2, q2, p1) is counterclockwise, (p2, q2, q1) are clockwise, and p1, p2, q1, and q2 are not collinear, the computer device determines that the first line segment and the second line segment intersect.

It should be understood that this embodiment only uses the above mode to determine whether the line segments intersect as an example for schematic illustration. In other possible implementations, the computer device may determine the line segment intersection by means of vector cross multiplication, which is not described in this embodiment.

Schematically, as shown in FIG. 14, for a target region E, the computer device determines 10 boundary links of the target region E, which are e1 to e10, respectively.

In a case that road-level traffic flow migration analysis is performed on the target region, since not all road network driving trajectories are the trajectories of vehicles when entering or leaving the target region, in order to avoid unnecessary calculations, in a possible implementation, before determining the candidate links included in the road network driving trajectory, the computer device first determines an origin region identifier and a destination region identifier corresponding to the road network driving trajectory, and in a case that the origin region identifier is consistent with a region identifier of the target region, or the destination region identifier is consistent with the region identifier of the target region (that is, the road network driving trajectory intersects with the region boundary of the target region), the candidate links contained in the road network driving trajectory are determined, so as to bring the road network driving trajectory into the road-level traffic flow migration analysis of the target region.

In response to the origin region identifier being different from the region identifier of the target region, and the destination region identifier being different from the region identifier of the target region (that is, the road network driving trajectory does not intersect with the region boundary of the target region), the computer device filters the road network driving trajectory, that is, the road network driving trajectory is not brought into the road-level traffic flow migration analysis of the target region.

The correspondence between the road network driving trajectory and the origin region identifier and the destination region identifier is generated in the process of determining the region-level traffic flow migration data.

2: Update traffic outflow data of the boundary link in response to the trajectory origin of the road network driving trajectory being within the target region and the trajectory destination being outside the target region.

After determining the boundary link, the computer device further determines that the road network driving trajectory is a trajectory of moving in the target region or a trajectory of moving out of the target region according to the origin and the destination of the road network driving trajectory, thereby updating the traffic inflow/outflow data of the boundary link.

3: Update traffic inflow data of the boundary link in response to the trajectory origin of the road network driving trajectory being outside the target region and the trajectory destination being within the target region.

Optionally, in a case that a trajectory origin of the road network driving trajectory is located in the target region and a trajectory destination is located outside the target region, the computer device updates the traffic outflow data of the boundary link, that is, an add-one operation is performed on the traffic outflow data of the boundary link. In a case that the trajectory origin of the road network driving trajectory is located outside the target region and the trajectory destination is located in the target region, the computer device updates the traffic inflow data of the boundary link, that is, the add-one operation is performed on the traffic inflow data of the boundary link.

In some embodiments, in a case that the computer device determines a boundary link passed when moving in and out based on the road network driving trajectory, whether the road network driving trajectory includes the determined boundary link may be first detected, and if not, then the boundary link is determined through the above steps, if yes, the inflow/outflow boundary link corresponding to the road network driving trajectory is directly updated, which facilitates reducing the calculation amount of road-level traffic flow migration analysis.

In a possible implementation, in the process of determining the region-level traffic flow migration data, the computer device generates the correspondences among the road network driving trajectory, the inflow region, and the outflow region (as shown in Table 1 in the embodiments above). In a case that road-level traffic flow migration analysis is performed, the computer device may further increase inflow boundary links passed when entering the inflow region and outflow boundary links passed when leaving the outflow region based on the correspondences. Schematically, the correspondences among the road network driving trajectory, the outflow region, the outflow boundary link, the inflow region, and the inflow boundary link are as shown in Table 3.

TABLE 3

| | | Outflow | | Inflow |
|---|---|---|---|---|
| Road network | Outflow | boundary | Inflow | boundary |
| driving trajectory | region | link | region | link |
| t₁ | a₁₁ | l₁₁ | a₁₂ | l₁₂ |
| t₂ | a₂₁ | l₂₁ | a₂₂ | l₂₂ |
| . . . | . . . | . . . | . . . | . . . |
| tₘ | aₘ₁ | lₘ₁ | aₘ₂ | lₘ₂ |

Based on the correspondences above, the computer device may filter the specified region, and collect statistics about the outflow boundary link and the inflow boundary link of the specified region, so as to obtain the traffic inflow/outflow data of the boundary link in the specified region.

4: Determine the traffic outflow data of the boundary link and the traffic inflow data of the boundary link as the road-level traffic flow migration data.

Furthermore, the computer device integrates the traffic outflow/inflow data of each boundary link in the target region, to obtain the road-level traffic flow migration data of the target region.

Schematically, for the target region E as shown in FIG. 14, the road-level traffic flow migration data determined by the computer device is as shown in Table 4.

TABLE 4

| | Number of vehicles | Number of vehicles |
|---|---|---|
| Boundary link | moving out | moving in |
| e₁ | f₁₁ | f₁₂ |
| e₂ | f₂₁ | f₂₂ |
| e₃ | f₃₁ | f₃₂ |
| . . . | . . . | . . . |
| . . . | . . . | . . . |
| e₉ | f₉₁ | f₉₂ |
| e₁₀ | f₁₀₁ | f₁₀₂ |

In this embodiment, the boundary link of the target region is determined by traversing each candidate link in the road network driving trajectory based on intersection with each region boundary, and the road-level traffic flow migration data of the target region is obtained based on the traffic inflow/outflow data of the boundary link, so as to implement micro-level traffic flow migration analysis.

For the mode of determining the target region in each embodiment, in a possible implementation, the target region is manually divided by the user. In response to a region division operation on a map, the computer device determines the target region based on a region boundary indicated by the region division operation.

Optionally, the region division operation may be a framing operation on the map, that is, the map is framed through a polygon wire frame (such as rectangle, other regular or irregular polygons) to identify a region within the polygon wire frame as the target region.

Optionally, after receiving the region division operation, the computer device determines a boundary coordinate point of the target region based on the location of the region division operation in the map, and stores the boundary coordinate point for subsequent traffic flow migration analysis. For example, in a case that the target region of the region division operation is a rectangle, the computer device determines the four vertexes of the rectangle as boundary coordinate points and stores same.

In another possible implementation, the target region is selected by the user from a pre-divided candidate region. In response to a selection operation on a candidate region in the map, the computer device determines the target region based on the selection operation. The candidate region is divided based on a region division rule, and the region division rule includes at least one of an administrative region division rule and a region size division rule.

For example, the candidate region is obtained by dividing the city on a district basis, or by dividing the province on a city basis, or by dividing a 10 km×10 km square region in advance.

Schematically, as shown in FIG. 15, the map is pre-divided into 3×3 candidate regions, and in a case that the user selects regions B and E, then the computer device performs only region/road-level traffic flow migration analysis for the regions B and E.

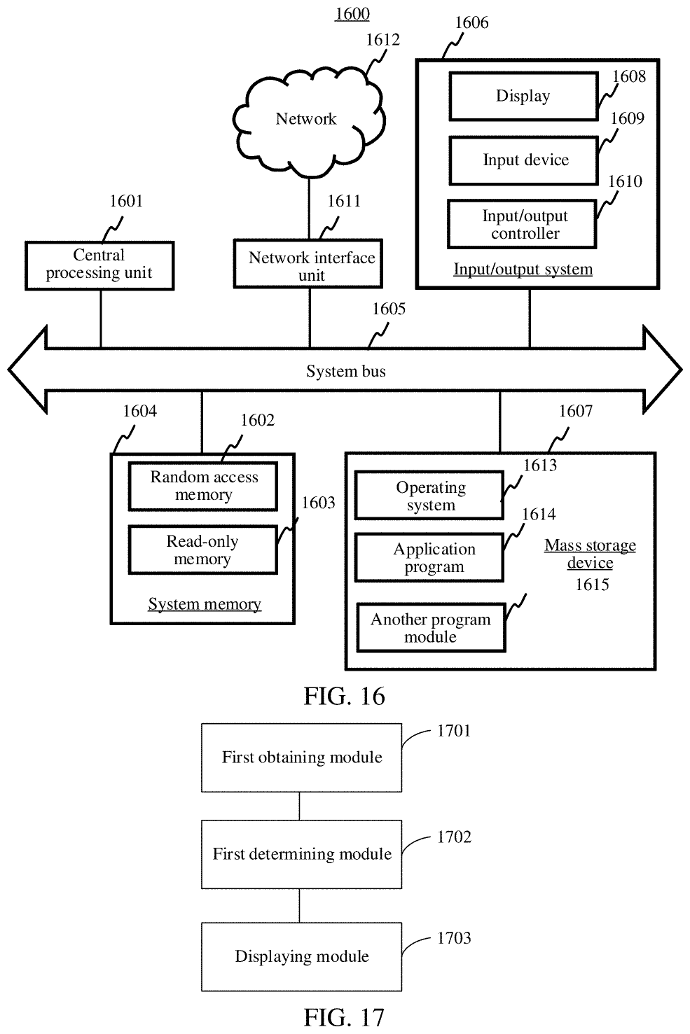

FIG. 16 is a schematic structural diagram of a computer device according to an exemplary embodiment of this application. Specifically, the computer device 1600 includes a Central Processing Unit (CPU) 1601, a system memory 1604 including a random-access memory 1602 and a read-only memory 1603, and a system bus 1605 connecting the system memory 1604 and the CPU 1601. The computer device 1600 further includes a basic Input/Output (I/O) system 1606 assisting in transmitting information between components in the computer, and a mass storage device 1607 configured to store an operating system 1613, an application program 1614, and another program module 1615.

The basic I/O system 1606 includes a display 1608 configured to display information and an input device 1609 such as a mouse or a keyboard that is configured to input the information by a user. The display 1608 and the input device 1609 are both connected to the CPU 1601 through an input/output controller 1610 connected to the system bus 1605. The basic I/O system 1606 may further include the input/output controller 1610 configured to receive and process inputs from a plurality of other devices such as a keyboard, a mouse, and an electronic stylus. Similarly, the input/output controller 1610 further provides an output to a display screen, a printer, or another type of output device.

The mass storage device 1607 is connected to the CPU 1601 through a mass storage controller (not shown) connected to the system bus 1605. The mass storage device 1607 and a computer-readable medium associated therewith provide non-volatile storage to the computer device 1600. That is, the mass storage device 1607 may include a computer-readable medium (not shown), such as a hard disk or a drive.

Generally, the computer-readable medium may include a computer storage medium and a communication medium. The system memory 1604 and the mass storage device 1607 may be collectively referred to as a memory.

The memory stores one or more programs. The one or more programs are configured to be executed by one or more CPUs 1601 and include instructions for implementing the method. The CPU 1601 executes the one or more programs to implement the method provided in the foregoing method embodiments.

According to the embodiments of this application, the computer device 1600 may further be connected, through a network such as the Internet, to a remote computer on the network and run. That is, the computer device 1600 may be connected to a network 1612 through a network interface unit 1611 connected to the system bus 1605, or may be connected to another type of network or a remote computer system (not shown) by using a network interface unit 1611.

The memory further includes one or more programs. The one or more programs are stored in the memory and include steps to be executed by the computer device in the method provided in the embodiments of this application.

FIG. 17 is a structural block diagram of a traffic flow migration situation display apparatus according to an exemplary embodiment of this application. The apparatus includes:
a first obtaining module 1701, configured to obtain a road network driving trajectory of a vehicle, the road network driving trajectory being used for representing a trajectory generated by the vehicle traveling in a road network, and the road network driving trajectory being composed of links in the road network;
a first determining module 1702, configured to determine traffic flow migration data of a target region based on a spatial positional relationship between the road network driving trajectory and the target region, the traffic flow migration data including region-level traffic flow migration data and road-level traffic flow migration data, the region-level traffic flow migration data being used for representing a traffic inflow/outflow situation of the target region, and the road-level traffic flow migration data being used for representing a traffic inflow/outflow situation of a boundary link of the target region; and
a displaying module 1703, configured to display a traffic flow migration situation of the target region based on the traffic flow migration data.

The first determining module 1702 includes:
a first determining unit, configured to determine a trajectory origin and a trajectory destination of the road network driving trajectory; and
a second determining unit, configured to determine the region-level traffic flow migration data of the target region based on a spatial positional relationship between the trajectory origin and the target region and a spatial positional relationship between the trajectory destination and the target region.

Optionally, the second determining unit is configured to:
update traffic outflow data of the target region in response to the trajectory origin being within the target region and the trajectory destination being outside the target region;
update traffic inflow data of the target region in response to the trajectory origin being outside the target region and the trajectory destination being within the target region; and
determine the traffic outflow data of the target region and the traffic inflow data of the target region as the region-level traffic flow migration data.

Optionally, the first determining module 1702 includes:
a third determining unit, configured to determine a candidate link contained in the road network driving trajectory; and
a fourth determining unit, configured to determine the road-level traffic flow migration data of the target region based on a spatial positional relationship between the candidate link and a region boundary of the target region.

Optionally, the fourth determining unit is configured to:
determine the candidate link intersecting the region boundary as the boundary link;
update traffic outflow data of the boundary link in response to the trajectory origin of the road network driving trajectory being within the target region and the trajectory destination being outside the target region;
update traffic inflow data of the boundary link in response to the trajectory origin of the road network driving trajectory being outside the target region and the trajectory destination being within the target region; and
determine the traffic outflow data of the boundary link and the traffic inflow data of the boundary link as the road-level traffic flow migration data.

Optionally, the first determining module 1702 further includes:
a fifth determining unit, configured to determine an origin region identifier and a destination region identifier corresponding to the road network driving trajectory, the origin region identifier and the destination region identifier being generated in a process of determining the region-level traffic flow migration data.

The third determining unit is configured to:
determine the candidate link contained in the road network driving trajectory in response to the origin region identifier being consistent with a region identifier of the target region, or the destination region identifier being consistent with a region identifier of the target region.

Optionally, the third determining unit is configured to:
determine a first line segment based on a link coordinate origin and a link coordinate destination of the candidate link;
determine a second line segment based on a first boundary coordinate point and a second boundary coordinate point of the region boundary; and
determine the candidate link as the boundary link in response to the first line segment intersecting the second line segment.

Optionally, the apparatus further includes:
a second obtaining module, configured to obtain driving sub-trajectory data of a vehicle, the driving sub-trajectory data including positioning point data of a positioning point in a vehicle driving process;
a second determining module, configured to determine a road network driving sub-trajectory of the vehicle based on the driving sub-trajectory data and road network data, the road network driving sub-trajectory being composed of links in the road network; and
a splicing module, configured to splice at least two road network driving sub-trajectories to obtain the road network driving trajectory.

Optionally, the second determining module includes:
a matching unit, configured to match the positioning point to a link in the road network based on the positioning point data and the link data of the link in the road network data; and
a generating unit, configured to generate the road network driving sub-trajectory based on the matched link.

Optionally, the splicing module includes:
an obtaining unit, configured to obtain an end time of an i^{th} road network driving sub-trajectory, and a start time of an (i+1)^{th} road network driving sub-trajectory, i being a positive integer;
a splicing unit, configured to splice the i^{th} road network driving sub-trajectory and the (i+1)^{th} road network driving sub-trajectory in response to a time interval between the end time and the start time being less than or equal to a threshold; and
an outputting unit, configured to output the spliced road network driving trajectory in response to the time interval between the end time and the start time being greater than a threshold.

Optionally, the apparatus further includes:
a third determining module, configured to determine, in response to a region division operation on a map, the target region based on a region boundary indicated by the region division operation;
or
a fourth determining module, configured to determine, in response to a selection operation on a candidate region in the map, the target region based on the selection operation, where the candidate region is divided based on a region division rule, and the region division rule includes at least one of an administrative region division rule and a region size division rule.

Optionally, the displaying module includes:
a first displaying unit, configured to generate a traffic inflow identifier and a traffic outflow identifier based on the region-level traffic flow migration data, and display the traffic inflow identifier and the traffic outflow identifier at a display region corresponding to the target region in the map; and/or,
a second displaying unit, configured to highlight the boundary link of the target region in the map based on the road-level traffic flow migration data, where the boundary links of different traffic inflow/outflow situations correspond to different display modes, and display, in response to a selection operation on a target boundary link, the road-level traffic flow migration data corresponding to the target boundary link.

In conclusion, in the embodiment of this application, in a case that the traffic flow migration analysis is performed on the target region, since the obtained road network driving trajectory of the vehicle is composed of links in the road network, in addition to determining the region-level traffic flow migration data at the macro level based on the spatial positional relationship between the road network driving trajectory and the target region, it is also possible to determine the road-level traffic flow migration data at the micro level that represents the traffic inflow/outflow situation of the boundary link. The data analysis dimension of traffic flow migration data is refined, which facilitates improving the utilization rate of traffic flow migration data. Moreover, compared with directly performing traffic flow migration analysis based on positioning point data of the vehicle in the related technology, performing the traffic flow migration analysis based on the road network driving trajectory mapped to the road network may avoid the problem of lower analysis accuracy caused by abnormal communication, positioning errors, and other reasons, further improving the accuracy of the traffic flow migration data.

It should be understood that the apparatus provided in the foregoing embodiments is illustrated with an example of division of the functional modules. In practical application, the foregoing functions may be allocated by different functional modules according to requirements, that is, the internal structure of the apparatus is divided into different functional modules, so as to complete all or part of the functions described above. In addition, the apparatus provided in the foregoing embodiments and the method embodiments fall within a same conception. For details of a specific implementation process, refer to the method embodiments. Details are not described herein again.

Embodiment of this application further provide a computer-readable storage medium. The readable storage medium stores at least one instruction that is loaded and executed by a processor to implement the traffic flow migration situation display method according to any one of the foregoing embodiments.

Embodiments of this application provide a computer program product or a computer program. The computer program product or the computer program includes a computer instruction stored in a computer-readable storage medium. A processor of a computer device reads the computer instructions from the computer-readable storage medium. The processor executes the computer instructions, so that the computer device executes the traffic flow migration situation display method according to the foregoing embodiments.

What is claimed is:

1. A traffic flow migration situation display method, executed by a computer device, the method comprising:
obtaining, by a processor, a road network driving trajectory of a vehicle, the road network driving trajectory representing a trajectory generated by the vehicle traveling in a road network, and the road network driving trajectory being composed of links in the road network;
determining traffic flow migration data of a target region based on a spatial positional relationship between the road network driving trajectory and the target region, the traffic flow migration data comprising region-level traffic flow migration data and road-level traffic flow migration data, the region-level traffic flow migration data representing a traffic inflow/outflow situation of the target region, and the road-level traffic flow migration data representing a traffic inflow/outflow situation of a boundary link of the target region; and
displaying, via a display screen, a traffic flow migration situation of the target region based on the traffic flow migration data.

2. The method according to claim 1, wherein determining traffic flow migration data of a target region based on a spatial positional relationship between the road network driving trajectory and the target region comprises:
determining a trajectory origin and a trajectory destination of the road network driving trajectory; and
determining the region-level traffic flow migration data of the target region based on a spatial positional relationship between the trajectory origin and the target region and a spatial positional relationship between the trajectory destination and the target region.

3. The method according to claim 2, wherein determining the region-level traffic flow migration data of the target region based on a spatial positional relationship between the trajectory origin and the target region and a spatial positional relationship between the trajectory destination and the target region comprises:
updating traffic outflow data of the target region in response to the trajectory origin being within the target region and the trajectory destination being outside the target region;
updating traffic inflow data of the target region in response to the trajectory origin being outside the target region and the trajectory destination being within the target region; and
determining the traffic outflow data of the target region and the traffic inflow data of the target region as the region-level traffic flow migration data.

4. The method according to claim 2, wherein determining traffic flow migration data of a target region based on a spatial positional relationship between the road network driving trajectory and the target region comprises:
determining a candidate link contained in the road network driving trajectory; and
determining the road-level traffic flow migration data of the target region based on a spatial positional relationship between the candidate link and a region boundary of the target region.

5. The method according to claim 4, wherein determining the road-level traffic flow migration data of the target region based on a spatial positional relationship between the candidate link and a region boundary of the target region comprises:
determining the candidate link intersecting the region boundary as the boundary link;
updating traffic outflow data of the boundary link in response to the trajectory origin of the road network driving trajectory being within the target region and the trajectory destination being outside the target region;
updating traffic inflow data of the boundary link in response to the trajectory origin of the road network driving trajectory being outside the target region and the trajectory destination being within the target region; and
determining the traffic outflow data of the boundary link and the traffic inflow data of the boundary link as the road-level traffic flow migration data.

6. The method according to claim 5, wherein determining the candidate link intersecting the region boundary as the boundary link comprises:
determining a first line segment based on a link coordinate origin and a link coordinate destination of the candidate link;
determining a second line segment based on a first boundary coordinate point and a second boundary coordinate point of the region boundary; and
determining the candidate link as the boundary link in response to the first line segment intersecting the second line segment.

7. The method according to claim 4, wherein before the determining a candidate link contained in the road network driving trajectory, the method further comprises:
determining an origin region identifier and a destination region identifier corresponding to the road network driving trajectory, the origin region identifier and the destination region identifier being generated in a process of determining the region-level traffic flow migration data; and
the determining a candidate link contained in the road network driving trajectory comprises:
determining the candidate link contained in the road network driving trajectory in response to the origin region identifier being consistent with a region identifier of the target region, or the destination region identifier being consistent with a region identifier of the target region.

8. The method according to claim 1, wherein before obtaining a road network driving trajectory of a vehicle, the method comprises:
obtaining driving sub-trajectory data of a vehicle, the driving sub-trajectory data comprising positioning point data of a positioning point in a vehicle driving process;
determining a road network driving sub-trajectory of the vehicle based on the driving sub-trajectory data and road network data, the road network driving sub-trajectory being composed of links in the road network; and
splicing at least two road network driving sub-trajectories to obtain the road network driving trajectory.

9. The method according to claim 8, wherein determining a road network driving sub-trajectory of the vehicle based on the driving sub-trajectory data and road network data comprises:
matching the positioning point to a link in the road network based on the positioning point data and a link data of the link in the road network data; and
generating the road network driving sub-trajectory based on the link in the road network.

10. The method according to claim 8, wherein the splicing at least two road network driving sub-trajectories to obtain the road network driving trajectory comprises:
obtaining an end time of an i^{th} road network driving sub-trajectory, and a start time of an (i+1)^{th} road network driving sub-trajectory, i being a positive integer;
splicing the i^{th} road network driving sub-trajectory and the (i+1)^{th} road network driving sub-trajectory to create a spliced road network driving trajectory in response to a time interval between the end time and the start time being less than or equal to a threshold; and
outputting the spliced road network driving trajectory in response to the time interval between the end time and the start time being greater than a threshold.

11. The method according to claim 1, further comprising:
determining, in response to a region division operation on a map, the target region based on a region boundary indicated by the region division operation;
or
determining, in response to a selection operation on a candidate region in the map, the target region based on the selection operation, wherein the candidate region is divided based on a region division rule, and the region division rule comprises at least one of an administrative region division rule and a region size division rule.

12. The method according to claim 1, wherein the displaying a traffic flow migration situation of the target region based on the traffic flow migration data comprises:
generating a traffic inflow identifier and a traffic outflow identifier based on the region-level traffic flow migration data; displaying the traffic inflow identifier and the traffic outflow identifier at a display region corresponding to the target region in a map; and/or
highlighting the boundary link of the target region in the map based on the road-level traffic flow migration data, wherein boundary links of different traffic inflow/outflow situations correspond to different display modes; and displaying, in response to a selection operation on a target boundary link, the road-level traffic flow migration data corresponding to the target boundary link.

13. A device, comprising:
a processor;
a display in communication with the processor; and
a memory in communication with the processor, the memory storing a plurality of instructions that, when executed by the processor, configure the processor to:
obtain a road network driving trajectory of a vehicle, the road network driving trajectory representing a trajectory generated by the vehicle traveling in a road network, and the road network driving trajectory being composed of links in the road network;
determine traffic flow migration data of a target region based on a spatial positional relationship between the road network driving trajectory and the target region, the traffic flow migration data comprising region-level traffic flow migration data and road-level traffic flow migration data, the region-level traffic flow migration data representing a traffic inflow/outflow situation of the target region, and the road-level traffic flow migration data representing a traffic inflow/outflow situation of a boundary link of the target region; and
display, on the display, a traffic flow migration situation of the target region based on the traffic flow migration data.

14. The device of claim 13, wherein when the processor is configured to determine traffic flow migration data of a target region based on a spatial positional relationship between the road network driving trajectory and the target region, the processor is further configured to:
determine a trajectory origin and a trajectory destination of the road network driving trajectory; and
determine the region-level traffic flow migration data of the target region based on a spatial positional relationship between the trajectory origin and the target region and a spatial positional relationship between the trajectory destination and the target region.

15. The device of claim 13, wherein when the processor is configured to determine traffic flow migration data of a target region based on a spatial positional relationship between the road network driving trajectory and the target region, the processor is further configured to:
determine a candidate link contained in the road network driving trajectory; and
determine the road-level traffic flow migration data of the target region based on a spatial positional relationship between the candidate link and a region boundary of the target region.

16. The device of claim 13, wherein the processor is further configured to:
obtain driving sub-trajectory data of a vehicle, the driving sub-trajectory data comprising positioning point data of a positioning point in a vehicle driving process;
determine a road network driving sub-trajectory of the vehicle based on the driving sub-trajectory data and road network data, the road network driving sub-trajectory being composed of links in the road network; and
splice at least two road network driving sub-trajectories to obtain the road network driving trajectory.

17. The device of claim 13, wherein when the processor is configured to display, on the display, a traffic flow migration situation of the target region based on the traffic flow migration data, the processor is further configured to:
generate a traffic inflow identifier and a traffic outflow identifier based on the region-level traffic flow migration data; displaying the traffic inflow identifier and the traffic outflow identifier at a display region corresponding to the target region in a map; and/or
highlight the boundary link of the target region in the map based on the road-level traffic flow migration data, wherein boundary links of different traffic inflow/outflow situations correspond to different display modes; and displaying, in response to a selection operation on a target boundary link, the road-level traffic flow migration data corresponding to the target boundary link.

18. A non-transitory computer-readable storage medium comprising a plurality of instructions stored thereon, the plurality of instructions configured to, when executed by a processor, cause the processor to:
obtain a road network driving trajectory of a vehicle, the road network driving trajectory representing a trajectory generated by the vehicle traveling in a road network, and the road network driving trajectory being composed of links in the road network;
determine traffic flow migration data of a target region based on a spatial positional relationship between the road network driving trajectory and the target region, the traffic flow migration data comprising region-level traffic flow migration data and road-level traffic flow migration data, the region-level traffic flow migration data representing a traffic inflow/outflow situation of the target region, and the road-level traffic flow migration data representing a traffic inflow/outflow situation of a boundary link of the target region; and
display a traffic flow migration situation of the target region based on the traffic flow migration data.

19. The non-transitory computer-readable storage medium of claim 18, wherein the plurality of instructions further comprises instructions to cause the processor to, when the processor is configured to determine traffic flow migration data of a target region based on a spatial positional relationship between the road network driving trajectory and the target region:
determine a trajectory origin and a trajectory destination of the road network driving trajectory; and
determine the region-level traffic flow migration data of the target region based on a spatial positional relationship between the trajectory origin and the target region and a spatial positional relationship between the trajectory destination and the target region.

20. The non-transitory computer-readable storage medium of claim 18, wherein the plurality of instructions further comprises instructions to cause the processor to, when the processor is configured to determine traffic flow migration data of a target region based on a spatial positional relationship between the road network driving trajectory and the target region:
determine a candidate link contained in the road network driving trajectory; and
determine the road-level traffic flow migration data of the target region based on a spatial positional relationship between the candidate link and a region boundary of the target region.
